(19) United States
(12) Patent Application Publication
(10) Pub. No.: US 2008/0267566 A1
(43) Pub. Date: Oct. 30, 2008

(54) FIBER ADAPTER AND SHUTTER MEMBER THEREOF

(75) Inventor: Samuel I. En Lin, Chu-Nan Town (TW)

Correspondence Address: PEPPER HAMILTON LLP, ONE MELLON CENTER, 50TH FLOOR, 500 GRANT STREET, PITTSBURGH, PA, 15219, US

(73) Assignee: SENKO ADVANCED COMPONENTS, INC., Marlboro, MA (US)

(21) Appl. No.: 12/035,669

(22) Filed: Feb. 22, 2008

Related U.S. Application Data
(63) Continuation-in-part of application No. 11/710,200, filed on Feb. 22, 2007, now abandoned.

(30) Foreign Application Priority Data
Mar. 20, 2006 (TW) 095109400

(51) Int. Cl. G02B 6/36

(52) U.S. Cl. 385/53

(57) ABSTRACT

A fiber adapter includes a housing having a plurality of side walls, the side walls defining a receiving recess for mating with a fiber connector, and an attachable, integrally formed shutter member. The shutter member includes a clip portion having opposing first and second ends, the first end provided with a clip recess configured to attach to one of the side walls and the second end comprising a hook, wherein the clip portion is configured to secure the shutter member to the housing, a protrusion formed at the first end of the clip portion and configured to extend away from the housing, and a curved elastic shutter plate extending from the first end of the clip portion and into the receiving recess.

### CROSS REFERENCE TO RELATED APPLICATION

This application is a continuation-in-part of U.S. application Ser. No. 11/710,200, filed Feb. 22, 2007. This application is related to Taiwan Patent Application Serial Number 095109400 filed Mar. 20, 2006, the full disclosure of which is incorporated herein by reference.

### BACKGROUND OF THE INVENTION

1. Field of the Invention

The present invention relates to a fiber adapter, and more particularly, to a fiber adapter with a shutter.

2. Description of the Related Art

Recently, the optical fiber has been widely used as a signal transmission media because of its high bandwidth and low loss nature. In order to transmit over a longer distance without the need for repeaters, it is common to use a high power diode laser to launch a laser beam into the optical fiber. However, the high power laser beam used to carry information is usually invisible. In other words, the human eyes will be unable to sense the high power laser beam if it leaves from the open end of a fiber cable. Thus, it is required to obstruct the high power laser beam to avoid hurting the eyes when the laser beam leaves from an optical fiber.

Referring to FIG. 1, a conventional fiber adapter 100 includes a housing 110 having a plurality of side walls 160. The side walls 160 define a receiving recess 120. One of the side walls 160 is provided with a slot 130 for mating with the key 192 of the connector 190 when the connector 190 is inserted into the receiving recess 120. In addition, the outer surfaces of two opposite side walls 160 are provided with recesses 140 onto which a clip (not shown in the figure) can be disposed to facilitate the adapter 100 to be mounted on a panel.

In general, the adapter 100 includes another set of side walls 160 that defines another receiving recess 120. The two receiving recesses 120 are opposite one another and can respectively receive a connector 190. In some cases, the two receiving recesses 120 of the adapter 100 can be designed to mate with two different types of connectors. The fiber connector 190 is attached to one end of a fiber cable 194 and a light beam can propagate down the fiber cable 194 and emit from the ferrule 196 of the connector 190. Likewise, a light beam can be coupled into the fiber cable 194 from the end face of the ferrule 196.

When the adapter 100 is used to couple two connectors 190 together, the two connectors 190 are respectively inserted into the receiving recesses 120. The ferrules 196 of the connectors 190 thus slide into a hollow sleeve (not shown in the figure) and are brought into axial alignment and contact with each other. A light beam will be able to propagate from the fiber cable 194 of a connector 190 through the interface between the two ferrules 196 and then reach the fiber cable 194 of the other connector 190, and vice versa.

When one connector 190 is disconnected from the adapter 100, the light beam originally propagating from the connector 190 still kept in the adapter 100 to the presently disconnected connector 190 will now leave the ferrule 196 and emit from the receiving recess 120. If the emitted light beam is high power and not obstructed, a lasting exposure to such light beam is harmful to people, particularly to the eyes. Thus, to avoid exposure to the high-power light beam, it is common to use a cap 180 to block the unused receiving recess 120. The cap can obstruct the light beam and also prevent dust from entering the receiving recess 120. If a connector 190 is mated with the adapter 100, the cap 180 must be removed. However, the cap 180 is apt to get lost and it is still possible to expose the eyes to the light beam during mating.

Referring to FIG. 2, a conventional fiber adapter 200 is generally the same as the adapter 100 but further includes a cover 250 pivotally connected to the housing 110. The cover 250 covers the receiving recess 120 in its closed position. A spring 260 can force the cover 250 to be pivoted to its closed position when the receiving recess 120 is not mated with a connector 190. Thus, the cover 250 is capable of obstructing the light beam emitted from the receiving recess 120 in its closed position. If a user would like to mate a connector 190 with the adapter 200, he is first required to lift the cover 250 from its closed position and then to insert the connector 190 into the receiving recess 120. Upon pulling out the connector 190, the cover 250 is pivoted to cover the receiving recess 120 through the spring 260. As a result, the user has no chance of exposure to the high-power light beam. However, the construction of the adapter 200 is more complex than that of the adapter 100.

Referring to FIG. 3, a conventional protection cap 300 for the fiber adapter 100 includes a hollow housing 310 with two opposing openings and a cover 350 pivotally connected to the housing 310. The cover 350 is pivoted to cover one of the two openings through a spring 360. The protection cap 300 can be put on the adapter 100 and cover the outer surfaces of the side walls 160 and the receiving recess 120 of the adapter 100. When a user would like to mate a connector 190 with the adapter 200, he is required to lift the cover 350 from its closed position and then to insert the connector 190 into the receiving recess 120. Likewise, upon pulling out the connector 190, the cover 350 is pivoted to cover the receiving recess 120 by the spring 360. As a result, the user will not be exposed to the high-power light beam emitted from the receiving recess 120. However, the structure of the protection cap 300 is somewhat complex and therefore it is not inexpensive. The introduction of the protection cap 300 to obstruct the light beam will cost much.

Accordingly, there exists a need to provide a shutter member to solve the aforesaid problems.

### SUMMARY OF THE INVENTION

It is an object of the present invention to provide a shutter member for fiber adapter that can obstruct the light beam emitted from the receiving recess and therefore avoid exposure to the light beam.

In general, in an aspect, the invention is directed to a fiber adapter. The fiber adapter includes a housing having a plurality of side walls, the side walls defining a receiving recess for mating with a fiber connector, and a shutter member comprising a clip portion having opposing first and second ends, the first end provided with a clip recess attached to one of the side walls, and an elastic shutter plate extending from the first end of the clip portion and into the receiving recess.

Embodiments of the invention may include one or more of the following features. The outside surface of the side wall can be provided with a recess and the clip portion may further comprise a hook disposed on the second end to hook on the recess of the outside surface of the side wall. The shutter member can be integrally formed and made of metal. The fiber adapter can be a SC type adapter. The fiber adapter can be a SC type duplex adapter. The elastic shutter plate can be curved.

In general, in another aspect, the invention provides a shutter member for a fiber adapter, the fiber adapter having a housing, the housing having a plurality of side walls, the side walls defining a receiving recess for mating with a fiber connector. The shutter member includes a clip portion having opposing first and second ends, the first end provided with a clip recess for attaching to one of the side walls, and an elastic shutter plate extending from the first end of the clip portion.

Embodiments of the invention may include one or more of the following features. The clip portion may comprise a hook disposed on the second end. The shutter member can be integrally formed and made of metal. The elastic shutter plate can be curved.

In general, in another aspect the invention provides a fiber adapter having a housing with a plurality of side walls, the side walls defining a receiving recess for mating with a fiber connector and an attachable, integrally formed shutter member. The shutter member includes a clip portion having opposing first and second ends, the first end provided with a clip recess configured to attach to one of the side walls and the second end comprising a hook, wherein the clip portion is configured to secure the shutter member to the housing, a protrusion formed at the first end of the clip portion and configured to extend away from the housing, and a curved elastic shutter plate extending from the first end of the clip portion and into the receiving recess. The protrusion can be configured to protrude from an edge of the side wall of the housing to form a contact point for a fiber connector.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an elevated perspective view illustrating a conventional fiber adapter and a conventional fiber connector.

FIG. 2 is an elevated perspective view of a conventional fiber adapter with a cover for obstructing the light beam emitted from the receiving recess.

FIG. 3 is an elevated perspective view of a conventional protection cap for a fiber adapter.

FIG. 4 is an elevated perspective view of a shutter member for a fiber adapter according to an embodiment of the present invention.

FIG. 5 is an elevated perspective illustrating that the shutter member of FIG. 4 is attached to a fiber adapter.

FIG. 6 is a sectional view illustrating that the shutter member of FIG. 4 is attached to a fiber adapter.

FIG. 7 is an elevated perspective illustrating that the shutter members of FIG. 4 are attached to an SC type duplex adapter.

FIG. 8 is a side perspective illustrating the shutter member at the insertion of a fiber adapter.

FIG. 9 is a perspective view of a shutter member for a fiber adapter.

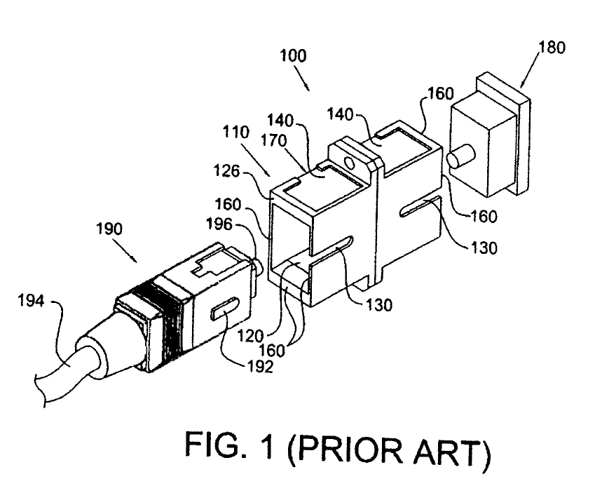

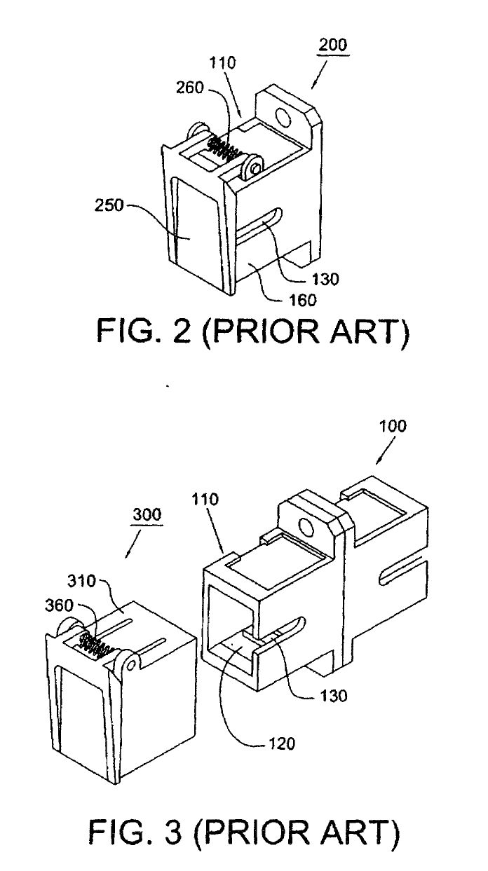

### DETAILED DESCRIPTION OF THE PREFERRED EMBODIMENT

Embodiments of the invention are directed to a shutter member for fiber adapter that can obstruct the light beam emitted from a receiving recess. The shutter member of the present invention can include a clip portion having opposing first and second ends and a curved elastic shutter plate. The first end of the clip portion can be provided with a clip recess for attaching to one of the side walls of the housing of the fiber adapter. The second end of the clip portion can be provided with a hook for hooking on the recess of the outside surface of the side wall to have the shutter member more firmly fastened to the fiber adapter. The curved elastic shutter plate extends from the first end of the clip portion and into the receiving recess of the fiber adapter to obstruct the light beam emitted therefrom when the shutter member is attached to the fiber adapter. The shutter member can remain in position when the fiber connector is inserted or removed. The shutter member can be configured such that the ferrule tip of the fiber connector does not make contact with the shutter member when inserted. Other embodiments are within the scope of the invention.

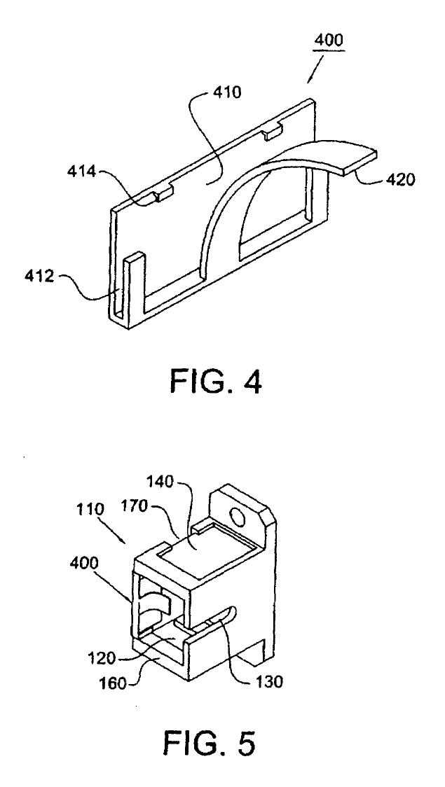

Referring to FIG. 4, a shutter member 400 for the fiber adapter 100 according to an embodiment of the present invention includes a clip portion 410 for attaching the shutter member 400 to the adapter 100 and a curved elastic shutter plate 420 extending from the clip portion 410. The one end of the clip portion 410 has a clip recess 412 for attaching to one of the side walls 160 and the other opposite end of the clip portion 410 has at least one hook 414.

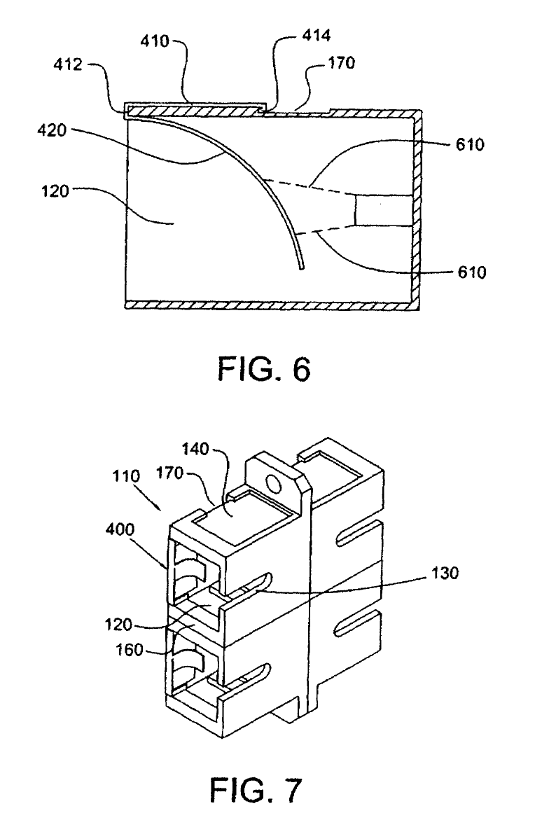

Referring to FIGS. 5 and 6, when the shutter member 400 is used in the adapter 100, the clip portion 410 is required to be attached to one of the side walls 160. The clip recess 412 is attached to the side wall 160 and the elastic shutter plate 420 extends into the receiving recess 120 to obstruct the light beam 610 emitted therefrom. As a result, the occurrence of exposure to the harmful light beam 610 can be avoided. The shutter member 400 does not need to be detached from the adapter 100 prior to inserting the connector 190 into the receiving recess 120. When the connector 190 is inserted into the receiving recess 120, it will push down the elastic shutter plate 420 to the gap between the connector 190 and the side wall 160. Upon pulling out the connector 190, the elastic shutter plate 420 will return to its original position to obstruct the light beam 610 as a result of elasticity.

The curved shutter plate 420 is configured to maximize the plate shape-memory such that the plate 420 substantially returns to its original shape when a connector is removed from the adapter. The shape of the shutter plate 420 is further configured to maximize the length of the plate 420 such that the large plate 420 provides cover over a substantial area of the light emitted.

Referring also to FIG. 8, the shutter member 400 includes a protrusion 430. The protrusion 430 comprises a gap 431. The protrusion 430 is configured to elongate the shutter plate 420. The protrusion 430 is configured to extend from the clip portion 410 such that upon insertion, the connector 190 is inserted into the receiving recess 120, the first contact point between the connector 190 and the shutter member 400 is the protrusion 430. The protrusion 430 is further configured such that the elastic shutter plate 420 bends in response to contact made with the protrusion 430. The elastic shutter plate 420 with the protrusion 430 is configured to avoid contact between the ferrule tip 196 and the shutter plate 420. The shutter plate 420 can be configured with multi-curved segments 421, configured to improve the shape memory of the plate 420. The multi-curved segments 421 are further configured to allow the connector 190 to be inserted without contact between the ferrule 196 and the plate 420. For example, a connector 190 inserted at an angle into the recess 120 (e.g., if the connector 190 is tilted when inserted, rather than inserted straight) will not cause the ferrule 196 to make contact with the shutter plate 420.

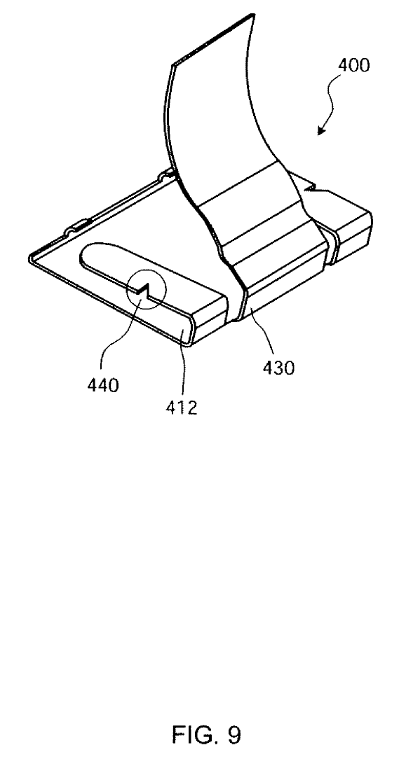

Referring also to FIG. 9, the clip recess 412 of the shutter member 400 includes a notch 440. The notch 440 is configured to attach to the side wall of the adapter 100. The notch 440 is configured to prevent removal of the shutter member 400 from the adapter 100. The shutter member 440 does not require repeated insertion and removal from the adapter 100.

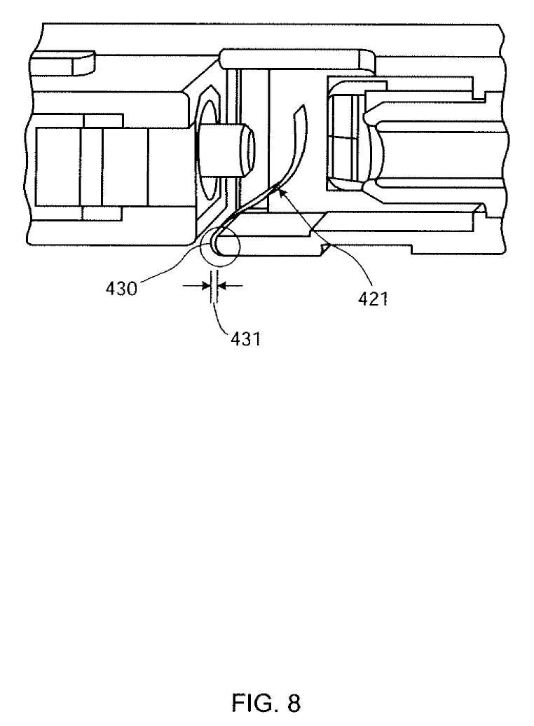

The shutter member 400 preferably is integrally formed and made of metal. The hook 414 can hook on the recess 170 arranged on the outside surface of the side wall 160 to have the shutter member 400 more firmly fastened to adapter 100. In addition, referring to FIG. 7, the shutter member 400 can be applied to the SC type duplex adapter 700.

The shutter member of the present invention is generally of simple construction and low production cost. Furthermore, there is no need to detach the shutter member from the adapter prior to mating a connector with the adapter.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A fiber adapter, comprising:
a housing having a plurality of side walls, the side walls defining a receiving recess for mating with a fiber connector; and
an attachable, integrally formed shutter member comprising:
a clip portion having opposing first and second ends, the first end provided with a clip recess configured to attach to one of the side walls and the second end comprising a hook, wherein the clip portion is configured to secure the shutter member to the housing;
a protrusion formed at the first end of the clip portion and configured to extend away from the housing; and
a curved elastic shutter plate extending from the first end of the clip portion and into the receiving recess.

2. The fiber adapter as claimed in claim 1, wherein the outside surface of the side wall is provided with a recess and the hook disposed on the second end of the clip portion is configured to hook on the recess of the outside surface of the side wall.

3. The fiber adapter as claimed in claim 1, wherein the shutter member is an integrally formed metal member.

4. The fiber adapter as claimed in claim 1, wherein the fiber adapter is a SC type adapter.

5. The fiber adapter as claimed in claim 4, wherein the fiber adapter is a SC type duplex adapter.

6. The fiber adapter as claimed in claim 1, wherein the protrusion is configured to protrude from an edge of the side wall of the housing to form a contact point for a fiber connector.

7. A shutter member for a fiber adapter, the fiber adapter having a housing, the housing having a plurality of side walls, the side walls defining a receiving recess for mating with a fiber connector, the shutter member comprising:
a clip portion having opposing first and second ends, the first end provided with a clip recess configured to attach to one of the side walls and the second end comprising a hook, wherein the clip portion is configured to secure the shutter member to the housing; and
a curved elastic shutter plate extending from the first end of the clip portion and into the receiving recess.

8. The shutter member as claimed in claim 7, wherein the clip portion further comprises a hook disposed on the second end.

9. The shutter member as claimed in claim 7, wherein the shutter member is integrally formed and made of metal.

10. The shutter member as claimed in claim 7, further comprising a protrusion formed at the first end of the clip portion configured to extend away from the housing.

11. The fiber adapter as claimed in claim 10, wherein the protrusion is configured to protrude from an edge of the side wall of the housing to form a contact point for a fiber connector.
